(19) United States
(12) Patent Application Publication
(10) Pub. No.: US 2003/0224158 A1
(43) Pub. Date: Dec. 4, 2003

(54) Tape-shaped member with hot melt glue

(76) Inventor: Chingsung Su, Taipei (TW)

Correspondence Address: Chingsung SU, PO Box 82-144, Taipei, TW

(21) Appl. No.: 10/159,031

(22) Filed: Jun. 3, 2002

(51) Int. Cl. B32B 7/12

(52) U.S. Cl. 428/343; 428/906

(57) ABSTRACT

A tape-shaped member with hot melt glue includes a rectangular substrate having a pair of folding lines along which said rectangular substrate is folded into a U-shaped member for receiving an edge of sheets of paper, and a hot melt glue arranged on said rectangular substrate between said folding lines, whereby the tape-shaped member can be used for keeping sheets of paper of various thicknesses and sizes adhered together by one edge and allows various kinds of covers to be used thereby enabling aesthetic choices and strengths.

### BACKGROUND OF THE INVENTION

1. Field of the Invention

This invention is related to a tape-shaped member with hot melt glue, and in particular to one having a substrate with hot melt glue to bend into a U-shaped structure to glue sheets of paper together at one edge.

2. Description of the Prior Art

The conventional way to glue sheets of paper is to use a film of PVC and paper board to form a fixed sized cover (For example, A4). Inside the cover, there is hot melt glue for gluing the sheets of paper within the cover together at one edge.

The drawback of the conventional structure is that the size of the adhering member cannot be adjusted as desired, and it is especially limited in adjusting to different paper lengths and thicknesses.

Therefore it is an object of the present invention to provide a tape-shaped member with hot melt glue to obviate and mitigate the above-mentioned drawbacks.

### SUMMARY OF THE INVENTION

This invention utilizes a substrate to form a U-shaped structure, so as to allow covers made of the same or different materials to be joined together while also having sheets of paper adhered together by one edge within the two covers, thereby providing more aesthetic and structural choices in determining the types of covers holding said sheets of paper therewithin.

Further, this invention utilizes a matrix arrangement of hot melt glue to adapt to the thickness and lengths of the sheets of paper being glued together. Furthermore, the tape-shaped member does not have folding lines, and is thus able to be shaped in different sizes of a U-shaped member, so as to adapt to different sizes and lengths of sheets of paper being adhered together.

Moreover, the cover may be made of transparent material such as PVC or thick paper board to provide different aesthetic choices and strengths of the material to be used as the cover, and the substrate may be made of fabric to provide different combinations and effects.

Another object of the present invention is to provide a tape shaped member of hot melt glue which can be adjusted to adhere to different paper sizes.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top plan view of the present invention.

FIG. 1A is a side view of FIG. 1

FIG. 2 illustrates how to affix covers to the present invention.

FIG. 2A illustrates how sheets of paper are adhered to the present invention.

FIG. 3 is a top plan view showing the arrangement of the hot melt glue.

FIG. 4A shows the present invention arranged in a continuous roll of tape.

FIG. 4B shows the present invention arranged as individual tape.

FIG. 5A shows one method of attaching the hot melt glue to the substrate.

FIG. 5B shows another method of attaching the hot melt glue to the substrate.

FIG. 6A is a front view of the cover using the tape member with hot melt glue.

FIG. 6B is a side view of FIG. 6A.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

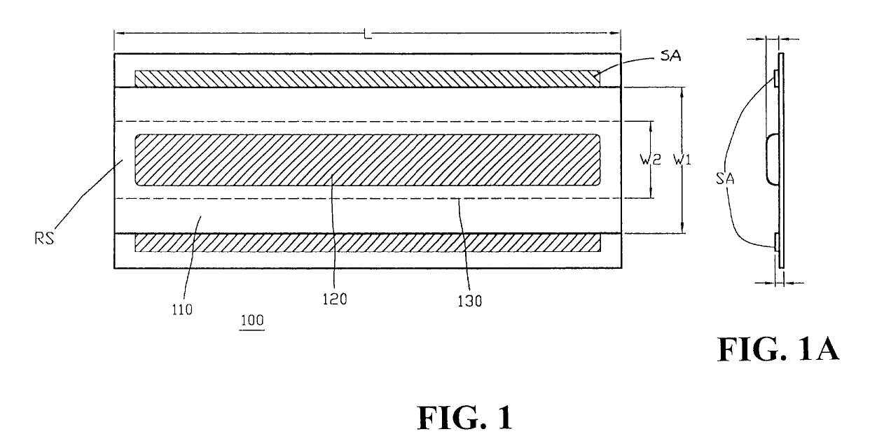

Referring to FIG. 1, the present invention comprises a substrate 110 which is rectangular in shape, and has a length L and widths W1 and W2. The length L may be any size, such as the length of A4 or A3 sizes, or may be cut into any designed size. W2 is designed to affix certain number of sheets of paper. Hence, W2 can be adjusted to adapt to different thicknesses of paper sheets. W1 is used to determining the height of the two sides of the U-shaped member formed from the tape-shaped member.

The first hot melt glue 120 is affixed to the inside of the substrate 110. The first hot melt glue 120 may be replaced with any other suitable adhesive material. The first hot melt glue 120 is preferably arranged within two folding lines 130, and there is a space RS at the two ends.

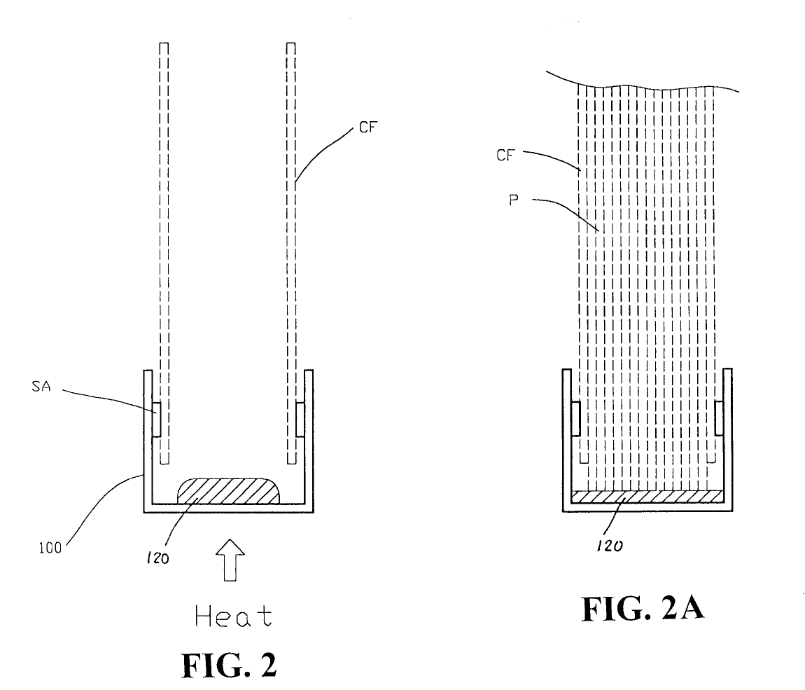

Referring to FIGS. 2 and 2A, the present invention is bent into a U-shaped member along the folding lines 130. Then covers CF which may be selected from different kinds of transparent material, and different kinds of patterns, thicknesses, color, or paper board, is adhered to the sides of the U-shaped member by means of the hot-melt glue or adhesive SA.

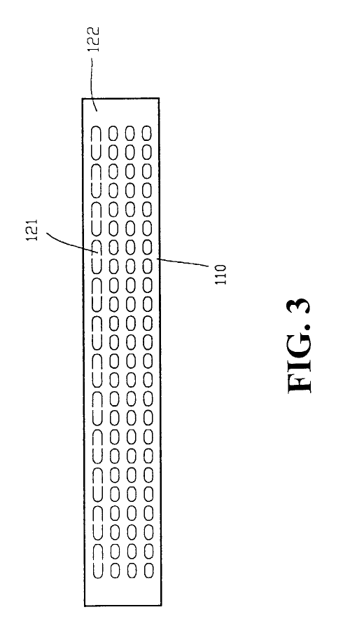

Referring to FIG. 3, the hot melt glue is arranged within the width W2, and the glue is arranged in interrupted longitudinal rows 121, so as to reduce the amount of glue used. Furthermore, the gluing length and thickness may be adjusted as desired. The arrangement of the interrupted hot melt glue longitudinal rows can provide better adhesive effect because they can be prevented from overflowing into the paper. In addition, it is possible to fold a line between any of the interrupted longitudinal rows of hot melt glue, thereby enabling different thicknesses of paper to be affixed to the tape shaped member.

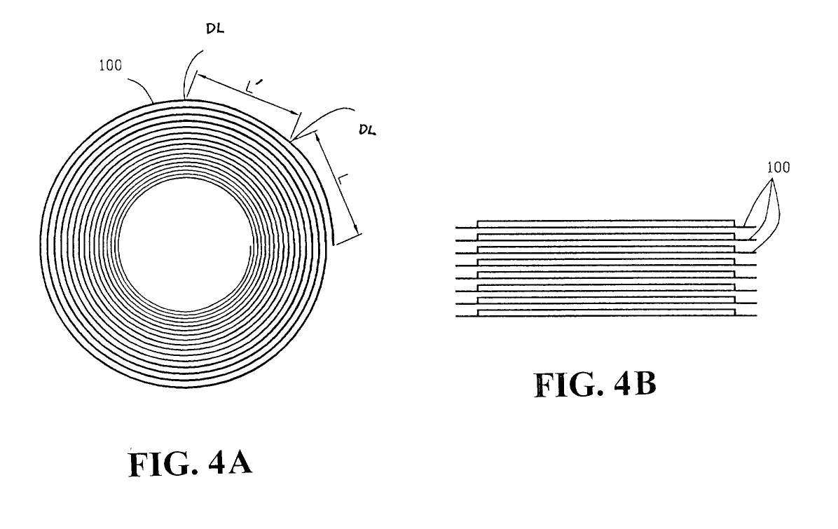

The tape-shaped member according to the present invention may be arranged in a roll as shown in FIG. 4A. As illustrated, the tape-shaped member 100 may be marked with a mark DL to show an L letter which represents the A4 size, or to show the L′ letter with represents the B5 size. FIG. 4B shows that the tape-shaped members 100 are arranged individually in a stack.

When in use the tape-shaped member is first bent into a U-shaped member then the desired covers are affixed to the inner workable side of the U-shaped member. Sheets of paper are then put inside the U-shaped member, then the hot melt glue is melted to join the papers and cover together.

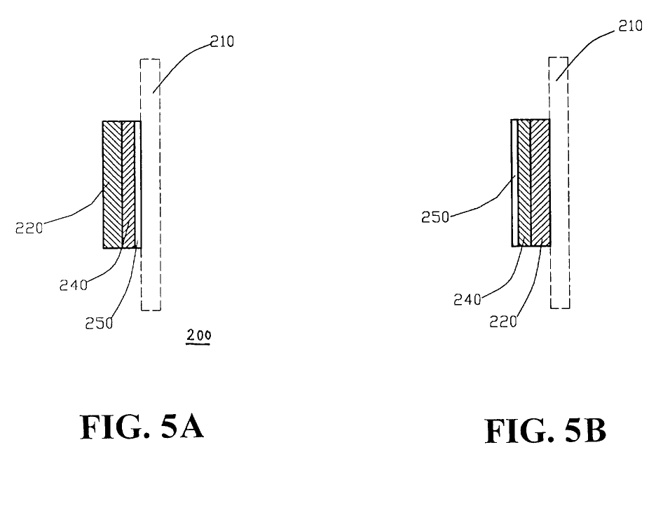

Referring to FIG. 5A, the hot melt glue 220 is first affixed to double-sided adhesive tape 240 which has peel-off paper. The peel-off paper is removed in order for the double-sided adhesive tape 240 to be adhered to the substrate 210 of the U-shaped member. In FIG. 5A, the hot melt glue will adhere to the paper sheets and covers held in the U-shaped member. In FIG. 5B, the hot melt glue is directly affixed to the substrate 210 and the double-sided adhesive tape 240 is attached to the other side of the hot melt glue 220. In FIG. 5B, the side of the double sided adhesive tape 240 not attached to the hot melt glue will adhere to the paper sheets and covers held in the U-shaped member.

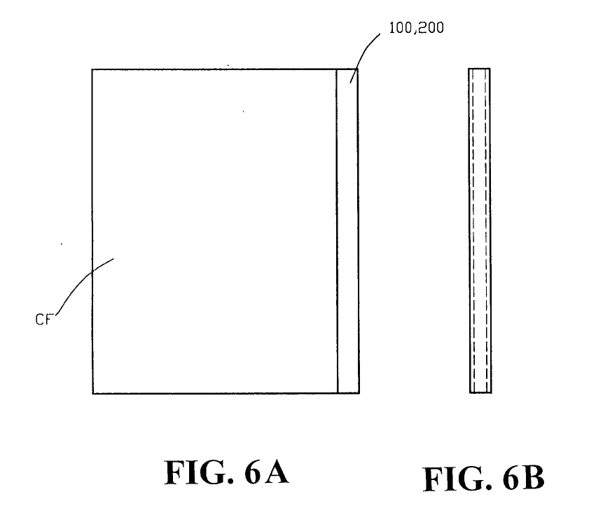

FIG. 6A is a front view of the cover using the tape member with hot melt glue. FIG. 6B is a side view of FIG. 6A.

Accordingly, the present invention has the following advantages: First, the present invention can be used for keeping sheets of paper of various thicknesses and sizes adhered together by one edge. Second, the present invention allows various kinds of covers to be used, thereby enabling aesthetic choices and strengths. Third, the present invention is fit for use for various kinds of machines or devices for gluing papers together, or suitable heating source may be used for the gluing.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tape-shaped member with hot melt glue comprising:
a rectangular substrate having a pair of folding lines along which said rectangular substrate is folded into a U-shaped member for receiving an edge of sheets of paper; and
a hot melt glue arranged on said rectangular substrate between said folding lines.

2. The tape-shaped member with hot melt glue as claimed in claim 1, wherein said hot melt glue is arranged in the glue is arranged in interrupted longitudinal rows so as to enable said U-shaped member to keep sheets of paper of various thicknesses and sizes adhered together by one edge.

3. The tape-shaped member with hot melt glue as claimed in claim 1, wherein said substrate is made of artificial or natural material.

4. The tape-shaped member with hot melt glue as claimed in claim 1, further comprising a double-sided tape affixed to each vertical inner side of said U-shaped member.

5. The tape-shaped member with hot melt glue as claimed in claim 1, further comprising a double-sided tape having one side affixed to said hot melt glue and another side to be affixed to sheets of papers.

6. The tape-shaped member with hot melt glue as claimed in claim 1, wherein said rectangular substrate is arranged in a roll.

7. The tape-shaped member with hot melt glue as claimed in claim 1, wherein a plurality of said rectangular substrates are arranged individually in a stack.
